(19) United States
(12) Patent Application Publication
(10) Pub. No.: US 2024/0152797 A1
(43) Pub. Date: May 9, 2024

(54) SYSTEMS AND METHODS FOR MODEL TRAINING AND MODEL INFERENCE

(71) Applicant: Genpact Luxembourg S.à r.l. II, Luxembourg (LU)

(72) Inventors: Rahul Verma, Haryana (IN); Gunjit Bedi, New Delhi (IN); Shubhro Pal, Haryana (IN); Darren Saumur, Toronto (CA); Rajarshi Sanyal, Haryana (IN); Sibasis Patro, Bhubaneswar (IN)

(21) Appl. No.: 17/982,091

(22) Filed: Nov. 7, 2022

(51) Int. Cl. G06N 20/00; G06N 5/02; G06N 7/00

(52) U.S. Cl. CPC G06N 20/00; G06N 5/022; G06N 7/005

(57) ABSTRACT

The disclosure relates to a method for generating a custom predictive model, the method comprising receiving a plurality of datasets; identifying a plurality of features affecting prediction of a predictive model; determining an importance score for each of the plurality of features; determining a probability of prediction for each dataset from the plurality of the datasets based on one or more features from the plurality of features for the prediction of each dataset, and respective importance scores for the one or more features; and training a custom predictive model using the plurality of datasets with the probabilities, the respective features, and the respective importance scores.

### TECHNICAL FIELD

The present systems and methods are directed to systems and methods for performing and visualizing model training and model inference through a graphical user interface.

### BACKGROUND

In the fields of finance, accounting, insurance, or healthcare, predictive models can be built to address functional problems or the movement of business metrics in the right direction. Traditionally, building models using machine learning requires expertise in data science, statistics, machine learning, and programming. However, for business teams, even if they are the data owners with an in-depth understanding of the process of building models, the requirement of expertise in data science, statistics, machine learning and programming is still a challenge for them to build these models. Therefore, there is a need to solve this problem.

### SUMMARY

In one aspect, the subject matter of this disclosure relates to a method for generating a custom predictive model, the method including receiving a plurality of datasets; identifying a plurality of features affecting prediction of a predictive model; determining an importance score for each of the plurality of features; determining a probability of prediction for each dataset from the plurality of the datasets based on one or more features from the plurality of features for the prediction of each dataset, and respective importance scores for the one or more features; and training a custom predictive model using the plurality of datasets with the probabilities, the respective features, and the respective importance scores. The method may further include displaying a user interface for configuring generation of the custom predictive model, the user interface including a first user interface element for selecting a type of the custom predictive model to be generated; and a second user interface element for identifying one or more categorical variables in one of the datasets. The method may be performed on a computing system having limited resources by at least one of using alternative working memory on the computing system and restricting processor utilization on the computing system. The plurality of features may include a document type of a dataset in the plurality of datasets and a type of service of datasets in the plurality of datasets. The custom predictive model may provide a ranking of the plurality of features affecting the prediction. The custom predictive model may provide a comparison of an actual dataset and one or more predictive datasets. The custom predictive model may provide an accuracy of the prediction based on the comparison. The probability of the prediction may indicate a confidence value of the prediction.

In one aspect, the subject matter of this disclosure relates to a system for generating a customed predictive model, the system including a memory; and one or more processors coupled with the memory, wherein the one or more processors, when executed, perform operations including receiving a plurality of datasets; identifying a plurality of features affecting prediction of a predictive model; determining an importance score for each of the plurality of features; determining a probability of prediction for each dataset from the plurality of the datasets based on one or more features from the plurality of features for the prediction of each dataset, and respective importance scores for the one or more features; and training a custom predictive model using the plurality of datasets with the probabilities, the respective features, and the respective importance scores. The system may further include a user interface for configuring generation of the custom predictive model, the user interface including a first user interface element for selecting a type of the custom predictive model to be generated; and a second user interface element for identifying one or more categorical variables in one of the datasets. The system may have limited resources by at least one of using alternative working memory on the system and restricting processor utilization on the system. The plurality of features may include a document type of a dataset in the plurality of datasets and a type of service of datasets in the plurality of datasets. The custom predictive model may provide a ranking of the plurality of features affecting the prediction. The custom predictive model may provide a comparison of an actual dataset and one or more predictive datasets. The custom predictive model may provide an accuracy of the prediction based on the comparison. The probability of the prediction may indicate a confidence value of the prediction.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 illustrates a flow diagram of creating a model by an analyst and a modelling system, according to various embodiments of the present disclosure.

FIG. 2, a flow diagram of an example of a current scenario of using the first-in, first-out (FIFO) method for processing invoices, according to various embodiments of the present disclosure.

FIG. 3A illustrates a flow diagram of an example for processing invoices based on a model, according to various embodiments of the present disclosure.

FIG. 3B illustrates a high-level flow diagram of the application with user interface to train a predictive model, according to various embodiments of the present disclosure.

FIG. 4 illustrates a schematic user interface of a desktop application including a model training module and a model inference module, according to various embodiments of the present disclosure.

FIG. 5 illustrates a schematic user interface of a desktop application including a user authentication module, according to various embodiments of the present disclosure.

FIG. 6 illustrates a schematic user interface of a desktop application including the model training module, according to various embodiments of the present disclosure.

FIG. 7 illustrates a flow diagram of a modelling training process, according to various embodiments of the present disclosure.

FIG. 8 illustrates exemplary modelling files and model evaluation reports for model training, according to various embodiments of the present disclosure.

FIG. 9 illustrates an exemplary model evaluation report, according to various embodiments of the present disclosure

FIG. 10 illustrates an exemplary feature importance report, according to various embodiments of the present disclosure

FIG. 11 illustrates an exemplary confusion matrix report, according to various embodiments of the present disclosure.

FIG. 12 illustrates an exemplary table of a relationship between model accuracy and data coverage, according to various embodiments of the present disclosure

FIG. 13 illustrates an exemplary model explainability report, according to various embodiments of the present disclosure.

FIG. 14 illustrates a table of abbreviation for each of the features in FIG. 13, according to various embodiments of the present disclosure.

FIG. 15 illustrates a schematic user interface of a desktop application including the model inference module, according to various embodiments of the present disclosure.

FIG. 16 illustrates a flow diagram of a model inference process, according to various embodiments of the present disclosure.

FIG. 17 illustrates an exemplary model prediction report of a model inference report, according to various embodiments of the present disclosure.

FIG. 18 illustrates an exemplary model explainability report of the model inference report, according to various embodiments of the present disclosure.

FIG. 19 illustrates a schematic user interface of model settings, according to various embodiments of the present disclosure.

FIG. 20 illustrates a table of one or more use cases using the application, according to various embodiments of the present disclosure.

FIG. 21 illustrates a table of one or more use cases using the application, according to various embodiments of the present disclosure.

FIG. 22 illustrates a table of one or more use cases using the application, according to various embodiments of the present disclosure.

FIG. 23 illustrates a block diagram of an application based on cloud service, according to various embodiments of the present disclosure.

FIG. 24 illustrates a type of user's computer showing a schematic diagram of a generic computer system, according to various embodiments of the present disclosure.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel. Any dimension or example part called out in the figures are examples only, and the example embodiments described herein are not so limited.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

With reference to the drawings, the invention will now be described in more detail. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Currently, consumers have infinite choices and want a service or a product right now rather than waiting for it. Companies or organizations face challenges to make their services or products available at the right place and the right time for their potential customers. Machine learning aims to solve the problem by helping companies or organizations fundamentally change the way that a business process runs in order to increase revenue, to decrease revenue leakage, and to prioritize customer satisfaction.

As mentioned above, the requirement of expertise in data science, statistics, machine learning, and programming for building models is a problem for a business team in an organization or a company. In addition, because of the cost and the bandwidth related challenges, data analytics teams sometimes may only provide limited support for the company or the organization. Therefore, the company or the organization may not be able to increase revenue, to decrease revenue leakage, or to prioritize customer satisfaction due to the shortage of expertise in data science, statistics, machine learning, and programming.

In another example, most operations nowadays are based on “first in, first out” (FIFO) method, which is a method for organizing the manipulation of a data structure where the first entry is processed first. Some operations are based on human judgement. Therefore, there is an opportunity to prioritize these requests using a machine learning algorithm based on prioritization of specific business value metrics, which uses a lightweight software utility.

In addition, for an analytical team, depending on the problem and the data, it may take two to three weeks to build an initial machine learning (ML) model and understand if the data has any predictive capability. Furthermore, sharing the data outside the information technology (IT) environment with third party analytics teams or with cloud service providers is an issue for customers since it introduces a risk of data leakage and being non-compliant with the General Data Protection Regulation (GDPR), the Health Insurance Portability and Accountability Act of 1996 (HIPAA), and other laws and regulations.

In an embodiment, in the present disclosure, a desktop application with a user interface (UI)/user experience (UX) in a modelling system is disclosed. The desktop application allows a user with no prior knowledge of data science or machine learning to build a custom predictive model with the click of a button.

The desktop application at the backend of the modelling system receives one or more user inputs and input data for model training and model inference. The desktop application automatically follows a lifecycle of building a deep learning based predictive model and further trains the deep learning based predictive model. The user of the modelling system receives the trained deep learning based predictive model as an output along with a model evaluation report. It is noted that the computations in the modelling system are performed internally in the user's system to ensure that data is not leaked outside of compliant environments and to adhere well with hardware limitations.

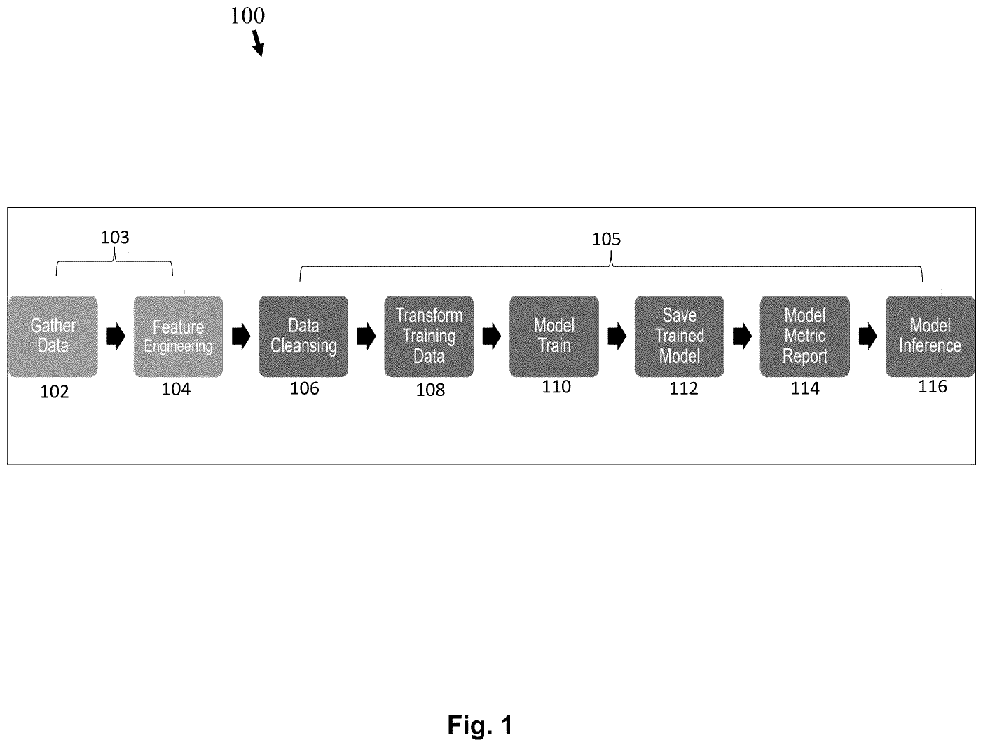

Referring to FIG. 1, a flow diagram 100 of creating a model by an analyst and a modelling system is shown, according to various embodiments of the present disclosure.

At block 102, an analyst 103 gathers data. The data may be related to the deep learning based predictive model. At block 104, the analyst 103 performs feature engineering. The feature engineering may be a process of selecting, manipulating, and transforming raw data into features that can be used in a machine learning process. In some embodiments, in order to make the machine learning work well on new tasks, it may be necessary to design and train more features related to the new tasks. At block 106, a desktop application 105 in the present disclosure may be used to perform a data cleansing. For example, the data received from the analyst 103 in block 104 may be cleaned. The data cleansing may include fixing or removing incorrect, corrupted, incorrectly formatted, duplicate, or incomplete data in a dataset. At block 108, the data after cleaning in the block 106 is transformed to be training data. At block 110, the desktop application 105 performs model training using the training data received in the block 108. At block 112, the model after training in the block 110 is saved in the desktop application 105 as a trained model. At block 114, a model metric report is created. The model metric report may include one or more evaluation metrics for evaluating a performance of a machine learning model. The model metrics may include, but are not limited to, error, precision, specificity, accuracy, and recall. At block 116, a model inference is performed. The model inference may be a process of running data points into a machine learning model to calculate an output such as a score. In some embodiments, the model inference may be a process to operationalize a machine learning model or put a machine learning model into production.

For illustrative purposes, the disclosed techniques will now be described in the context of creating a customized machine learning model to predict whether invoices will be timely paid. It is to be appreciated, however, that such techniques are generally applicable and there are limitless use cases to which they may be applied. For example, the presently disclosed techniques can be used by a sales office associate, who has no machine learning knowledge, to create a custom machine learning model through a simple user interface that determines the likelihood that the demand for a product will increase. As another example, the disclosed techniques can be used by management personnel at an automotive manufacturer to create a custom machine learning model that predicts whether parts will arrive on time.

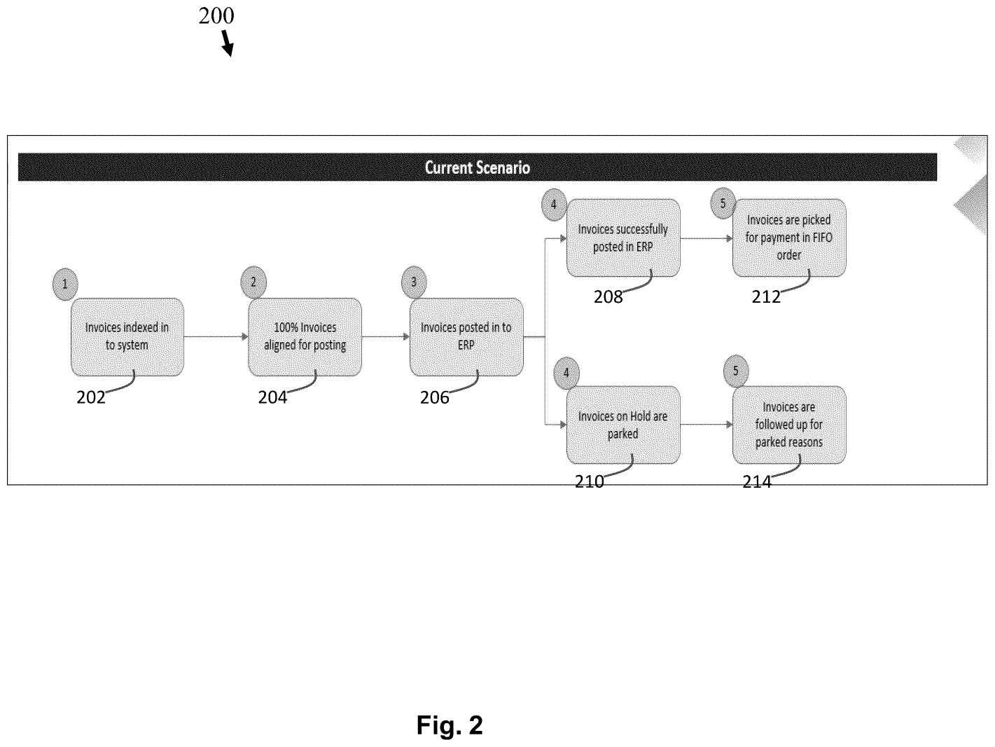

Referring to FIG. 2, a flow diagram 200 of an example of a current scenario of using the first-in, first-out (FIFO) method for processing invoices is shown, according to various embodiments of the present disclosure.

In one embodiment, the desktop application in the present disclosure may be used in the fields of finance and accounting. For example, in an interconnected world of global business, organizations depend on services, raw materials, and parts that support a value chain of finished products. Organizations interact with thousands of vendors to keep the value chain functioning well and pay for services and products they receive.

In one example, for an accounts payable process, payments to vendors or suppliers are done within agreed terms to maintain business continuity, positive vendor or supplier sentiment, and to capture any discounts linked to early payments. A vendor may have a potential to disrupt the supply chain for an organization, which leads to a lower order fulfilment. A final derivation of the vendor is loss in revenue and profit for the organization. However, some major organizations deal with thousands of vendors and suppliers globally which results in hundreds of invoices being sent to the operations team for clearance. This puts pressure on the operations team to clear the posted invoices in the queue which is done in first-in, first-out (FIFO) method. When the volume of the invoices increases for any reason, the operations team may have to increase manpower to solve it rather than understanding the business value by leveraging the business data using machine learning. The challenge is that the invoices which have a high probability for being paid late due to multiple factors may still have to wait in the queue and follow the designed process. This results in invoices being paid late to the vendors or suppliers. A similar situation may also exist in the accounts receivables process to understand which invoice to collect.

Returning to FIG. 2, at block 202, each invoice of a plurality of invoices is indexed into a system such as an invoice processing system. At block 204, all invoices are aligned for posting. At block 206, all invoices are posted into an enterprise resource planning (ERP) system. Based on whether each invoice may be posted in the ERP system, the invoice may be posted to the ERP system or on hold. If one or more invoices are posted successfully, then the one or more invoices may stay in the ERP system as shown in block 208. The one or more invoices posted in the ERP system may then be paid in the FIFO order as shown in block 212. If one or more invoices are on hold, then the one or more invoices may be parked as shown in block 210. The parked one or more invoices means that the one or more invoices are entered into a queue into the ERP system but are not yet be posted into the ERP system. After the one or more invoices are parked, a follow up for each of the parked one or more invoices may be performed to understand the reasons for parking.

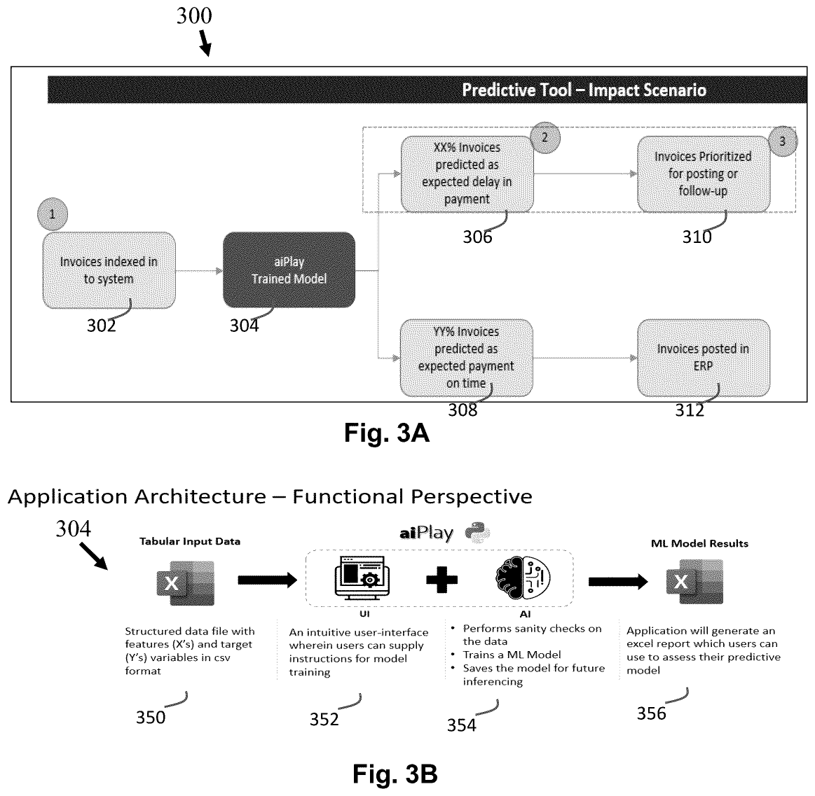

Referring to FIG. 3A, a flow diagram 300 of an example for processing invoices based on a model is shown, according to various embodiments of the present disclosure.

As discussed above in FIG. 2, because the invoices using the FIFO method create some issues, a desktop application to train a predictive model in the present disclosure may be used to predict historically paid invoices, which will be discussed in FIG. 3A. For example, the trained model in the present disclosure may predict if any invoice may be paid on time or may be paid late along with probability of that happening. The trained model may be used every day in an organization to prioritize the invoices with a high probability of being paid late. Therefore, the trained model in the present disclosure may have an impact on the paid on time metrics. For example, the trained model in combination with the current invoice payment system may provide a quicker processing time to pay or reject an invoice. The desktop application with the user interface (UI)/user experience (UX) to train the predictive model in the present disclosure also provides the customers that have no prior knowledge of data science or machine learning to build the predictive model with a click of a button.

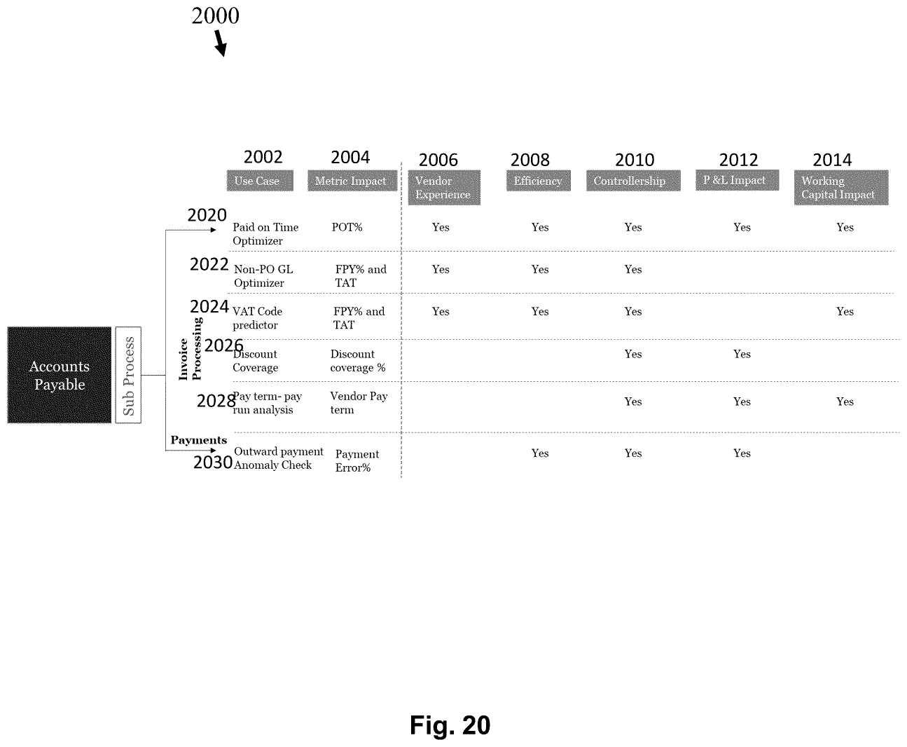

Returning to FIG. 3A, at block 302, each invoice of a plurality of invoices is indexed into a modelling system such as an invoice processing system. At block 304, a desktop application in the present disclosure is used to train a predictive model for the invoice payment system. At block 306, based on the predictive model, a first plurality of the invoices may be predicted as expected delay in payment. After the first plurality of the invoices being expected delay in payment, the first plurality of the invoices may be prioritized for posting in the ERP system or labelled as follow-up as shown in block 310. At block 308, based on the predictive model created in the block 304, a second plurality of the invoices may be predicted as expected payment on time. The second plurality of the invoices may then be posted in the ERP system as shown in block 312. It is noted that the predictive model created by the desktop application in the present disclosure may be easily used with a click of a button by users of the desktop application with user interface (UI)/user experience (UX) function. Therefore, the implementation of the predictive model approach in the present disclosure may help the users to improve the paid on time metric and to derivatively increase a vendor satisfaction. In addition, the approach of leveraging artificial intelligence (AI) for invoice prioritization based on desktop application with UI/UX is also disclosed in the present disclosure, which will be discussed later in FIGS. 20-22.

Referring to FIG. 3B, a high-level flow diagram of the application with user interface to train a predictive model is shown, according to various embodiments of the present disclosure.

The desktop application with user interface to train the predictive model is discussed above in block 304 in FIG. 3B At block 350, the desktop application receives input data such as tabular input data, which is in a structured data file with features and target variables in a spreadsheet file format, e.g., an Excel file. At block 352, the user interface is provided for the users of the model training system. The users may provide one or more user inputs through the user interface. At block 354, sanity checks on input data may be performed. A machine learning predictive model may be trained. The trained model may be used for the model inference. At block 356, the desktop application generates a report which the users may use for accessing the predictive model.

The desktop application in the present disclosure may be a standalone desktop based binary application developed in end-to-end with one or more design principles. The desktop application may not need installation since it is a self-executable application. The desktop application may be optimized for low-end hardware, e.g., laptops, virtual machines, and remote desktops. The desktop application may be data integrity compliant, which does not require application programing interface (API) calls or any database connectivity. The desktop application may have an access control, which may be available by a user subscription. The desktop application may be customized for process requirements.

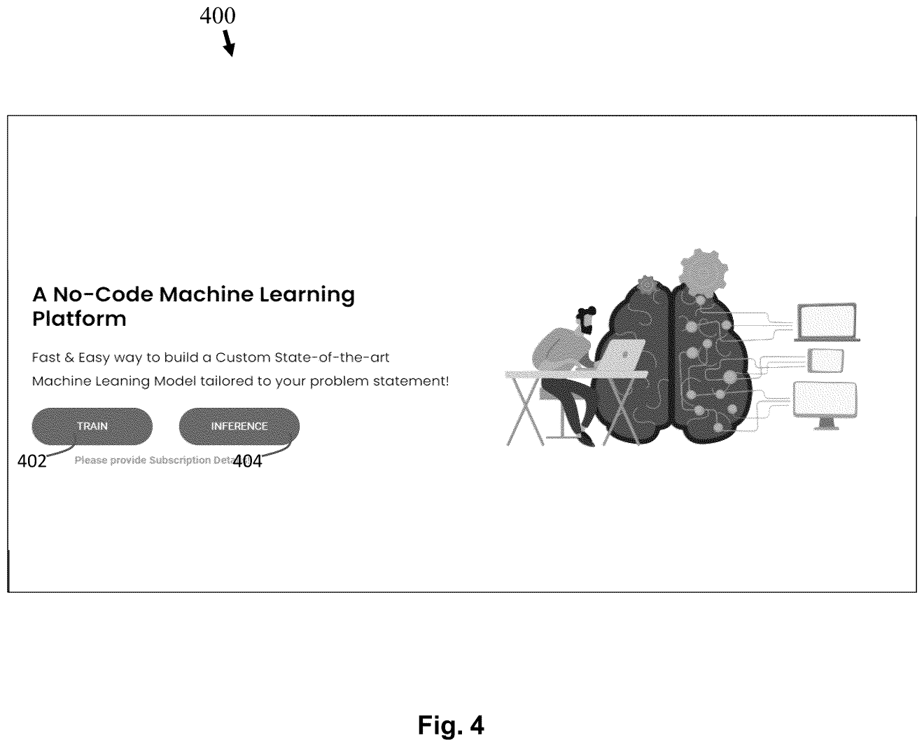

Referring to FIG. 4, a schematic user interface 400 of a desktop application including a model training module and a model inference module is shown, according to various embodiments of the present disclosure.

As discussed above, machine learning has been used only by those who have the educational and professional skill to leverage data science to build machine learning models. The conventional way is introducing the data analytics team or a data scientist to the operation's team who may start with understanding the problem or the objective, and then building a required predictive model by machine learning. In some embodiments, building machine learning models uses a third party cloud service providers with the AI services. However, using the third party cloud services may have data security and compliance related issues since the data needs to be transmitted from customer's environment to the third party cloud service providers, which becomes a concern for customers in the fields of healthcare, insurance, and banking. The cost related to building the predictive ML model also increases due to the usage of ecosystems from the third party cloud service providers from the third party companies. In addition, even the automatic machine learning (AutoML) from the third party cloud service providers can automatically train and tune multiple ML algorithms; however, any step before and after a training step for the machine learning model still needs to be performed manually. Therefore, the desktop application with the UI/UX in the present disclosure may be used to solve the problem.

Returning back to FIG. 4, the user interface (UI) 400 of a desktop application to train a predictive ML model is shown. The UI 400 on the desktop application does not require programming skills nor computer coding experience for the users of the ML modelling system. The UI 400 includes two modules with clickable buttons. A first module using a first clickable button is a “model training” module 402, and a second module using a second clickable button is a “model inference” module 404. The users of the ML modelling system may click the “model training” module 402 to perform the training of the machine learning models without the prior knowledges of data science or machine learning. The users of the ML modelling system may further click the “model inference” module 404 to perform a prediction using the trained model created earlier when the users clicked the “model training” module 402. The results of the model inference calculated by the trained model may be displayed by the UI 400 for the users of the ML modelling system as an output.

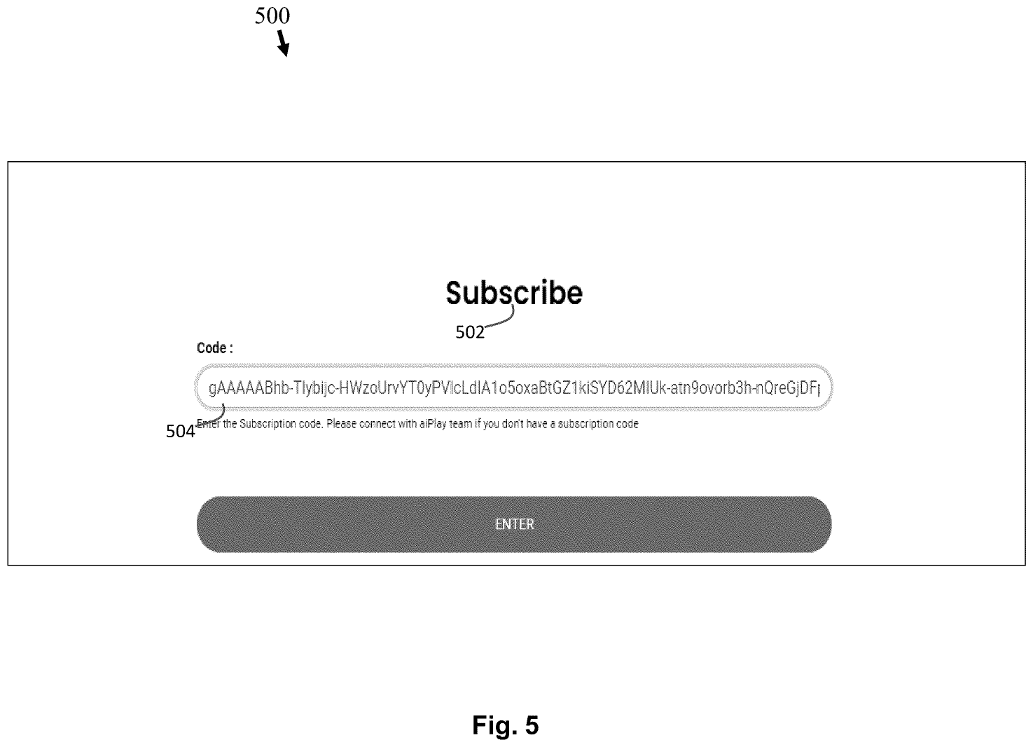

Referring to FIG. 5, a schematic user interface 500 of a desktop application including a user authentication module 502 is shown, according to various embodiments of the present disclosure.

In one embodiment, for the user authentication module 502, a fernet cryptography-based encryption or decryption technique to authenticate users of the desktop application is used at the backend of the modelling system. This method guarantees that a message encrypted using the fernet cryptography-based encryption or decryption technique may not be manipulated or read without an encryption key.

As shown in FIG. 5, the user of the desktop application is provided with a unique encrypted subscription code 504 tied to the user's system name and expiration date. Once the user enters the provided subscription code 504 through the user interface 500, the desktop application decrypts the subscription code 504, which provides the user's system name and the expiration date of the user's subscription. The desktop application then matches the user's system name from the subscription code 504 with an actual system's name on which the application is running and validates whether the current system's date is earlier than the expiration date from the user's subscription. If both validations are successful, then the user is authenticated into the modelling system.

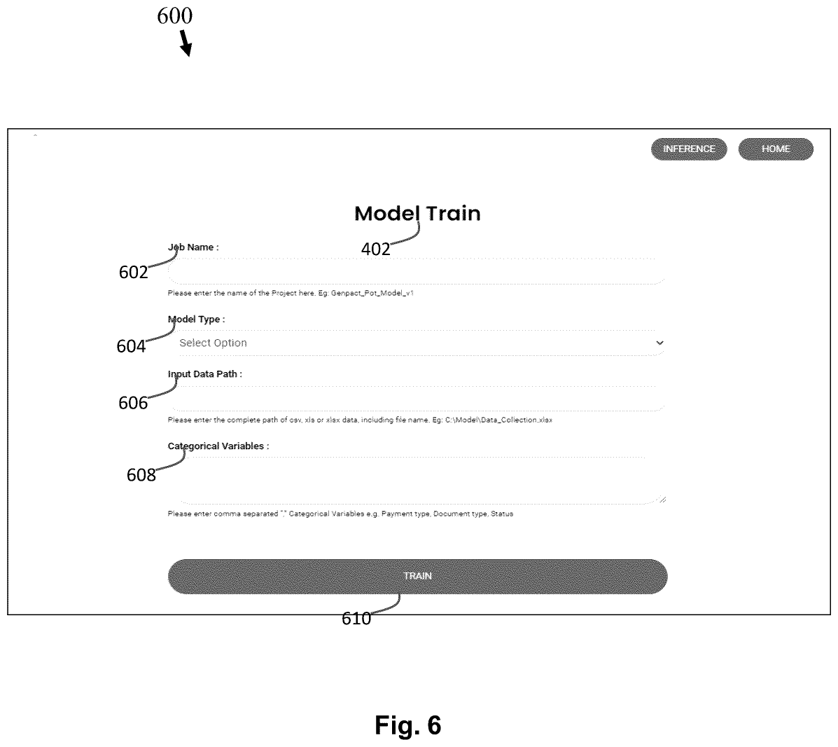

Referring to FIG. 6, a schematic user interface 600 of a desktop application including the model training module 402 is shown, according to various embodiments of the present disclosure.

As discussed above in FIG. 4, after the user clicks the model training module 402, the desktop application of the modelling system enters a user interface 600, as shown in FIG. 6. In order to train a machine learning model, the user of the model training engine in the modelling system needs to provide one or more inputs, which is shown in the user interface 600.

A first input is a job name 602. The user of the modelling system may provide any alphanumeric job name. The job name 602 may be used to create folders in the user's local drive on the user's computer where the desktop application may save logs, trained model pickle files, and model evaluation reports for the user.

A second input is a model type 604. The user of the modelling system may assign the desktop application to train a classification based model or a regression model based on use case requirements.

A third input is an input data path 606. The input data path 606 is a path to the input data files, which may be comma-separated values (CSV) files or Excel files. The desktop application may automatically consider a first column in the dataset as a target variable, and the other columns may include variables that may be considered as independent variables or features for model training.

A fourth input is a categorical variable 608. All the column names of all categorical variables present in the dataset may be provided in comma-separated format.

After the user provides all these four inputs into the user interface 600, the user may click on the TRAIN 610 button to initiate the model training engine.

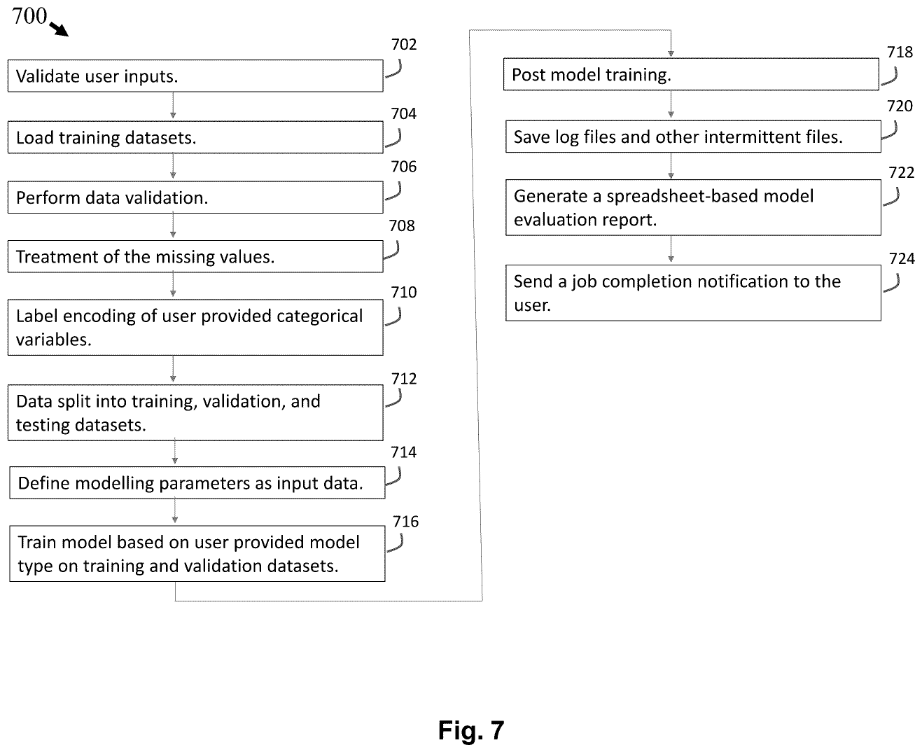

Referring to FIG. 7, a flow diagram 700 of a modelling training process is shown, according to various embodiments of the present disclosure.

At block 702, user inputs are validated. The validation includes checking if required fields discussed above in FIG. 6 are provided. The validation also includes validating that the provided format of the inputs is correct. At block 704, training dataset is loaded. Input data file formats may be adjudicated. The input data file formats may include csv, xls, or xlsx format. The data is loaded accordingly. At block 706, data validation is performed. The data validation may include checking that target variable may not have missing values. Categorical variables list provided by the user has to be available in the input dataset. At block 708, missing values are treated. For numeric variables, “0” may be used to fill out the missing values by default. For categorical variables, dummy text may be used to fill out the missing values by default.

At block 710, encoding of user provided categorical variables is labelled. The categorical variables which have text may be chosen for label encoding. Text-based inputs may be converted to integer format so the machine learning algorithm may ingest these variables for training. At block 712, data splits into training, validation, and testing datasets. By default, entire data is randomly split into model training, validation, and testing. Model training data accounts for 80% of the entire data; validation data accounts for 10% of the entire data; and testing data accounts for 10% of the entire data, although other splits may be used. The model training data and the validation data may be used during the model training. However, the testing data may not be used during the model training, and the testing data may only be used for model evaluation. At block 714, modelling parameters as input data is defined. The required parameter values may be received as input data to train the modelling algorithm. At block 716, the modelling is trained when the user of the modelling system provides the model type on the training and the validation datasets. During the model training, the model is trained for 30 epochs by default. It is noted that an epoch is a single iteration through the training data. The validation dataset may be used to estimate model performance after each epoch and decide if the model training may continue or it may need to be terminated if the model does not learn any further.

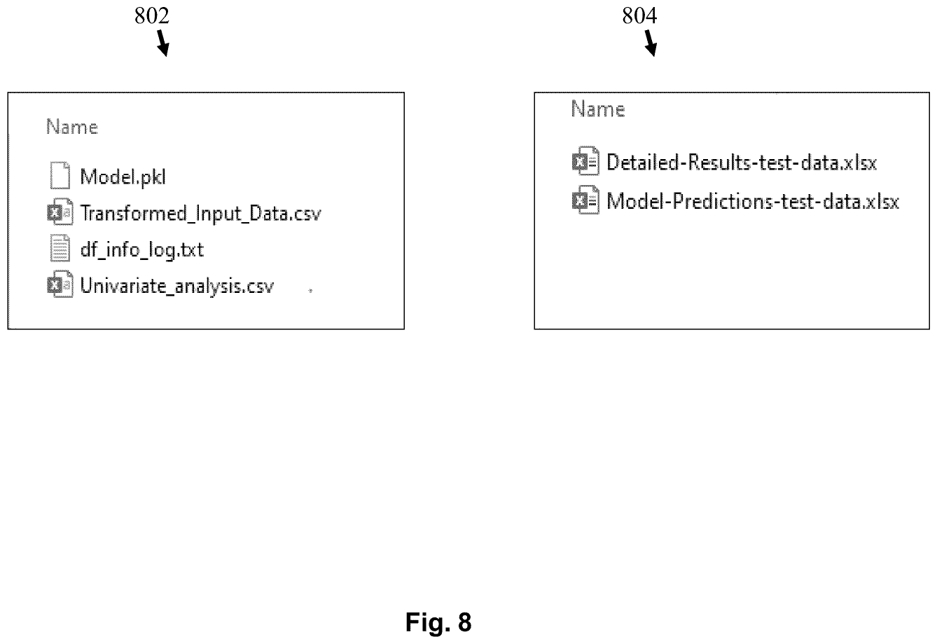

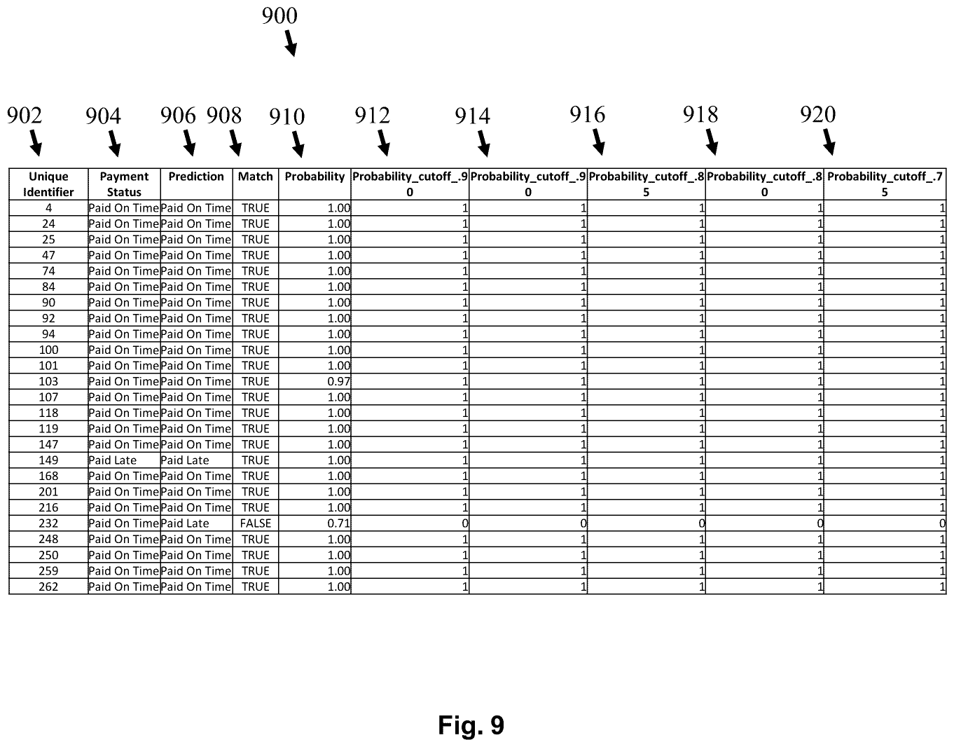

At block 718, post model training is performed. One or more objects may be listed in a file, e.g., pickle file, on the user's computer system, which may be shown later in FIG. 8. The one or more objects may include job name, trained ML model, label encoder, and categorical variables. At block 720, log files and other intermittent files are saved. At block 722, a spreadsheet-based model evaluation report is generated. The spreadsheet-based model evaluation report may use excel spreadsheet, which may be shown later in FIGS. 8-13. The model evaluation report may include a model prediction report, a confusion matrix report, a feature importance report, a model accuracy analysis report, and a model explainability report, which are shown later in FIG. 9-13. At block 724, a job completion notification is sent to the user.

Referring to FIG. 8, exemplary modelling files and model evaluation reports for model training are shown, according to various embodiments of the present disclosure.

In one embodiment, as discussed above in block 718 in FIG. 7, one or more objects may be listed in the file, e.g., the pickle file, on the user's computer system. For example, as shown in block 802, the block 802 may include pickles files, log files, transformed input data intermittent files.

In one embodiment, as discussed above in block 722 in FIG. 7, a spreadsheet-based model evaluation reports may be listed in the block 804 in FIG. 8. For example, the block 804 may include a spreadsheet of detailed test result data and a spreadsheet of model prediction test data.

Referring to FIG. 9, an exemplary model evaluation report 900 is shown, according to various embodiments of the present disclosure. It is noted that the model evaluation report 900 in FIG. 9 is generated after the model is trained.

In one embodiment, a detailed model evaluation report 900 includes results from a comparison of an actual dataset and a predicted dataset. The model evaluation report 900 includes one or more columns, e.g., columns 902, 904, 906, 908, 910, 912, 914, 916, 918, and 920. Column 902 represents numeric identifiers for one or more datasets. The numeric identifiers in the column 902 may be used to map the model training data, the validation data, and testing data in the block 712 discussed above. For example, the one or more datasets may include dataset #4, dataset #24, dataset #25, dataset #47, etc. Column 904 represents a result of an actual payment status for each of the datasets if the dataset paid on time. For example, dataset #4 has an actual payment status showing “paid on time”. Column 906 represents whether the dataset is predicted to pay on time. For example, by using the predictive model in the present disclosure, the dataset #4 is predicted to pay on time and the dataset #232 is predicted to pay late. Column 908 represents whether there is a match between the payment status and the predicted payment status. For example, the dataset #4 has an actual payment status showing “paid on time” and is predicted to pay on time then the match between the actual payment status and the predicted payment status is “true.” In another example, the dataset #232 has a payment status showing “paid on time” but is predicted to pay late, then the match between the actual payment status and the predicted payment status is “false.” Column 910 represents a probability which is a confidence level of the training model in making the prediction in column 906. For example, for the dataset 103, the probability of 0.97 may represent that the training model is 97% confident in predicting a transaction of the dataset 103 to pay on time. The probability in the column 910 may be a probability score or a confidence score for the prediction of the payment status in the training model. If the probability score or the confidence score is higher, then the possibility of the prediction being correct is also higher. Column 912 represent a cutoff of the probability at 0.95. For example, the probability of the dataset #103 is 0.97. Since the probability of the dataset #103 is larger than 0.95, a numeric value of “1” is given for the dataset #103. Column 914 represent a cutoff of the probability at 0.9. For example, the probability of the dataset #232 is 0.71. Since the probability of the dataset #232 is less than 0.9, a numeric value of “0” is given for the dataset #232. Column 916 represent a cutoff of the probability at 0.85. For example, the probability of the dataset #232 is 0.71. Since the probability of the dataset #232 is less than 0.85, a numeric value of “0” is given for the dataset #232. Column 918 represent a cutoff of the probability at 0.8. For example, the probability of the dataset #90 is 1. Since the probability of the dataset #90 is larger than 0.82, a numeric value of “1” is given for the dataset #90. Column 920 represent a cutoff of the probability at 0.75. For example, the probability of the dataset #119 is 1. Since the probability of the dataset #119 is larger than 0.75, a numeric value of “1” is given for the dataset #119.

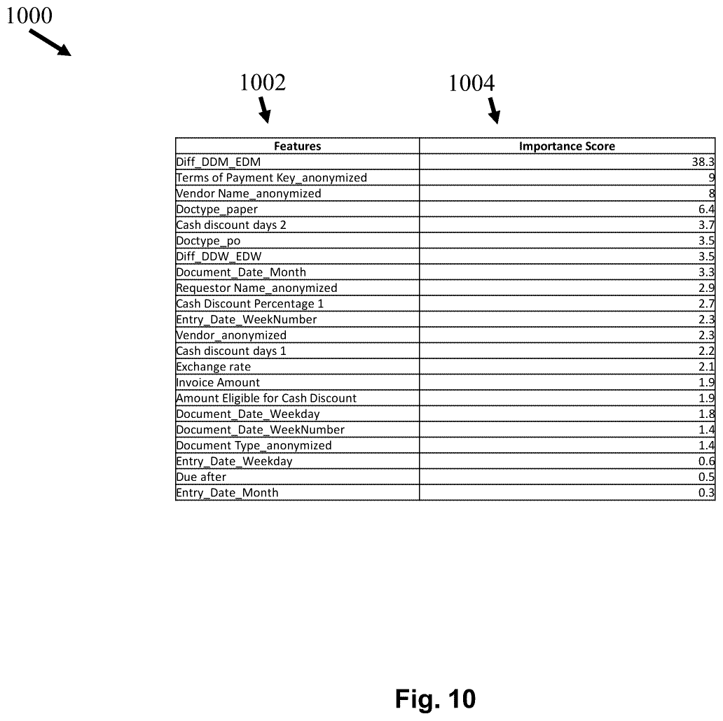

Referring to FIG. 10, an exemplary feature importance report 1000 is shown, according to various embodiments of the present disclosure. It is noted that the feature importance report 1000 in FIG. 10 is generated after the model is trained.

In one embodiment, the feature importance report 1000 may be part of the model evaluation report 900. The feature importance report 1000 includes column 1002 and column 1004. The column 1002 may include one or more features for the model and the column 1004 may include importance scores for the one or more features. For example, the feature “Difference between number of months of the invoice indexing date and invoice date” may have an importance score of “38.3.” The feature importance scores in the column 1004 may be calculated during the model training by the user provided historical dataset. The importance score is better when higher.

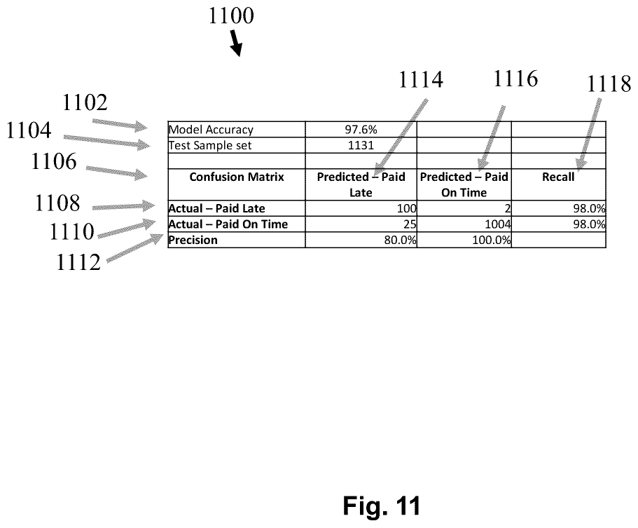

Referring to FIG. 11, an exemplary confusion matrix report 1100 is shown, according to various embodiments of the present disclosure. It is noted that the confusion matrix 1100 in FIG. 11 is generated after the model is trained.

In one embodiment, the confusion matrix report 1100 may be part of the model evaluation report 900. The confusion matrix report may include a model accuracy 1102 and a number of test sample set 1104. The confusion matrix also includes row 1108, row 1110, row 1112, column 1114, column 1116, and column 1118. The row 1108 represents a number of the test sample sets that actually paid late. The row 1110 represents a number of the test sample sets that actually paid on time. The column 1114 represents the number of test sample sets that predictively pay late and the column 1116 represent the number of test sample sets that predictively pay on time.

The row 1112 represents a precision rate of a predicted late payment 1114 for the test sample sets that actually fail, and a precision rate of a predicted on-time payment 1116 for the test sample sets that actually paid on time.

For example, the number of test sample sets that actually paid late and predictively pay late is 100 and the number of the test sample sets that actually paid on time but predictively pay late is 25. Therefore, the precision rate 1112 of the predicted late payment 1114 is that the number of the test sample sets that actually paid late and predictively pay late divides by a sum of the number of the test sample sets that actually paid late and predictively pay late and the number of the test sample sets that actually paid on time but predictively pay late, which may be shown below in Equation 1.

$$P 1 = \frac{( n 1 )}{( n 2 + n 3 )} \qquad ( Equation 1 )$$

In Equation 1, P1 is a precision rate of the predicted pay late. n1 is the number of the test sample sets that actually paid late and predictively pay late. n2 is the number of the test sample sets that actually paid late and predictively pay late. n3 is the number of the test sample sets that actually paid on time but predictively pay late.

For example, the number of test sample sets that actually paid late but predictively pay on time is 2 and the number of the test sample sets that actually paid on time and predictively pay on time is 1004. Therefore, the precision rate 1112 of the predicted pay on time 1116 is that the number of the test sample sets that actually paid on time and predictively pay on time divides by a sum of the number of the test sample sets that actually paid late but predictively pay on time and the number of the test sample sets that actually paid on time and predictively pay on time, which may be shown below in Equation 2.

$$P 2 = \frac{( n 4 )}{( n 5 + n 6 )} \qquad ( Equation 2 )$$

In Equation 2, P2 is a precision rate of the predicted pay on time. n3 is the number of the test sample sets that actually paid on time and predictively pay on time. n4 is the number of the test sample sets that actually paid on time and predictively pay on time. n6 is the number of the test sample sets that actually paid late but predictively pay on time.

Column 1118 is a recall rate of the actual late payment 1108 and the actual on-time payment 1110. For example, the recall rate 1118 of the actual late payment 1108 is that the number of the test sample sets that actually paid late and predictively pay late divides by a sum of the number of the test sample sets that actually paid late and predictively pay late and the number of the test sample sets that actually paid late but predictively pay on time, which may be shown below in Equation 3.

$$R 1 = \frac{( n 1 )}{( n 1 + n 6 )} \qquad ( Equation 3 )$$

In Equation 3, R1 is a recall rate of the actual paid late, and n1 and n6 are described above.

The recall rate 1118 of the actual on-time payment 1110 is that the number of the test sample sets that actually paid on time and predictively pay on time divides by a sum of the number of the test sample sets that actually paid on time and predictively pay on time and the number of the test sample sets that actually paid on time but predictively pay late, which may be shown below in Equation 4.

$$R 2 = \frac{( n 4 )}{( n 4 + n 3 )} \qquad ( Equation 4 )$$

In Equation 4, R2 is a recall rate of the actual on-time payment, and n4 and n3 are described above.

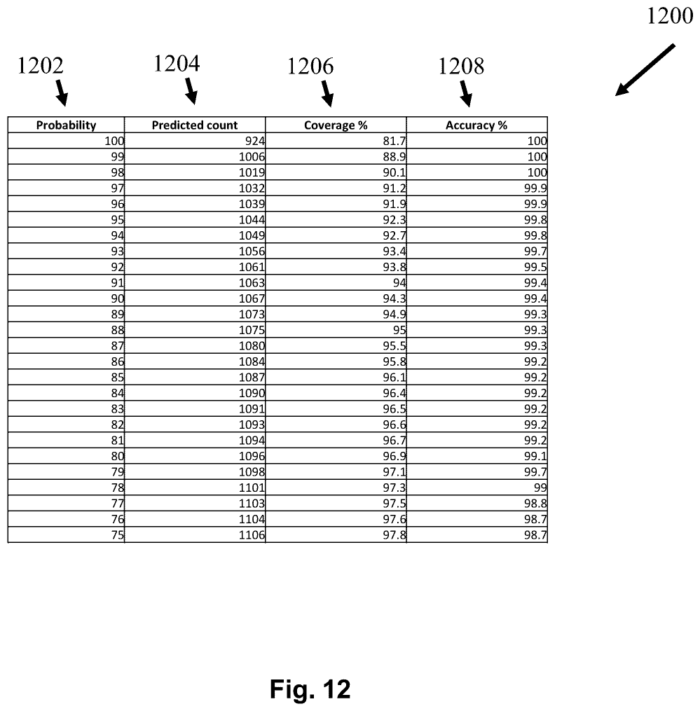

Referring to FIG. 12, an exemplary table 1200 of a relationship between model accuracy 1208 and data coverage 1206 is shown, according to various embodiments of the present disclosure. It is noted that the table in FIG. 12 is generated after the model is trained.

In one embodiment, the table 1200 provides a trade-off between the model accuracy 1208 and the data coverage 1206 based on a probability threshold 1202. The probability threshold 1202 represent a threshold value in a unit of percentage for a predicted count 1204. The predicted count 1204 represents a number of the datasets with a probability that is greater than the probability threshold 1202, and the probability may be calculated in the column 910 in FIG. 9.

The data coverage 1206 represents a percentage of datasets having probabilities that are greater than the probability threshold 1202. The model accuracy 1208 represents an accuracy score for each probability threshold 1202.

In an embodiment, the probability threshold 1202 may be used to filter datasets based on their probabilities. For example, if a probability threshold 1202 is 0.95 or 95%, an dataset or an invoice has a probability less than 0.95 or 95% may be discarded and the dataset may be sent to an exception queue in the training model. It is noted that the datasets in the exception queue may be processed manually by the user of the system.

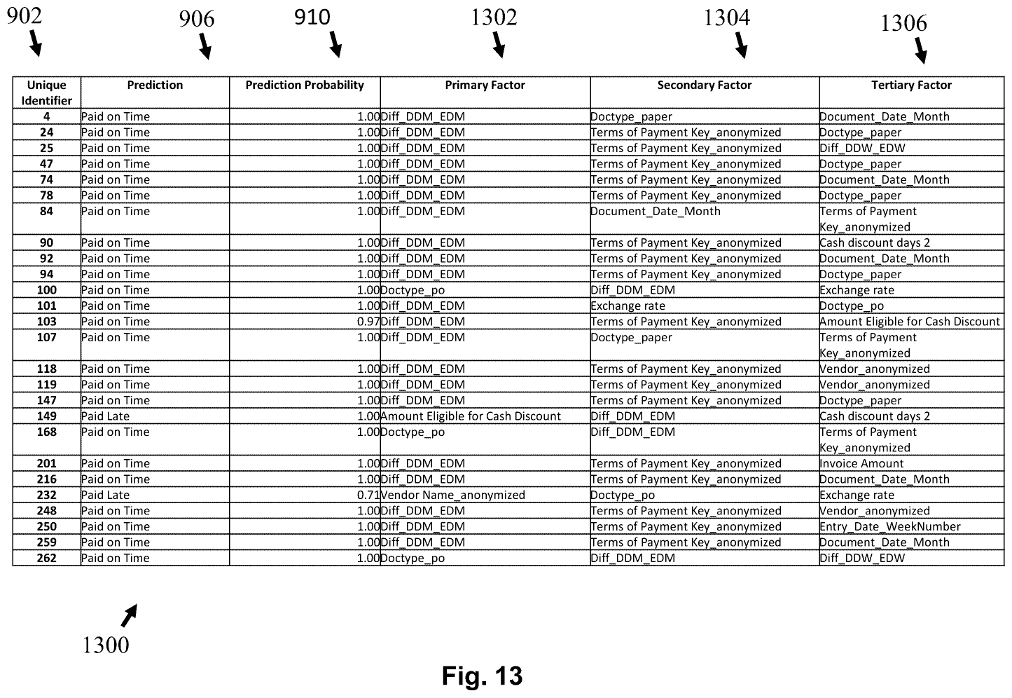

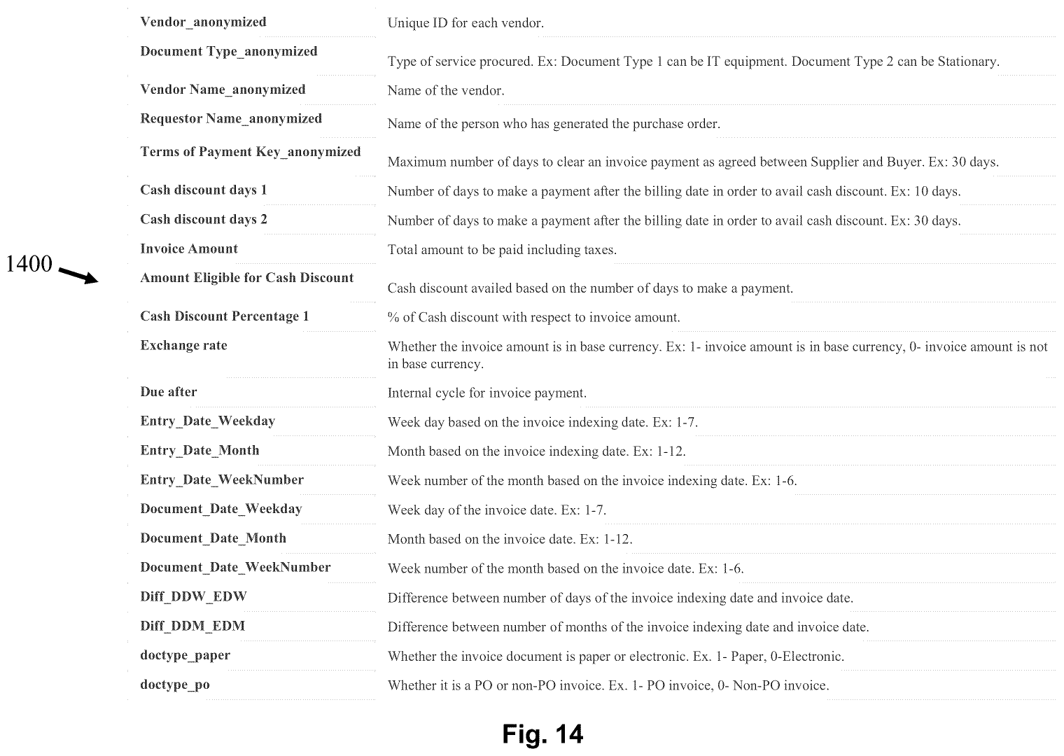

Referring to FIG. 13, an exemplary model explainability report 1300 is shown, according to various embodiments of the present disclosure. Referring to FIG. 14, a table 1400 of abbreviation for each of the features in FIG. 13 is shown, according to various embodiments of the present disclosure. It is noted that the model explainability report 1300 in FIG. 13 is generated after the model is trained.

In FIG. 13, the model explainability report 1300 includes columns 902, 906, 910, 1302, 1304, and 1306. The column 1302 represents a primary factor. The column 1304 represents a secondary factor. The column 1306 represents a tertiary factor. The feature in the primary factor 1302 represents a feature with a highest influence for the dataset, therefore, a prediction in the model training using this feature may be due to value present under this feature in a dataset. In addition, the feature in the secondary factor 1304 represents a feature with a second highest probability for the dataset, and the feature in the tertiary factor 1306 represents a feature with a third highest probability for the dataset. For example, the dataset #103 has a prediction probability 910 of 0.97 and the prediction 906 is that the dataset #103 may pay on time. The primary factor 910 for the dataset #103 is “Diff_DDM_EDM,” which is a “difference between number of months of the invoice indexing date and invoice date,” as indicated in FIG. 14. The secondary factor for the dataset #103 is “Terms of Payment Key_anonymized,” which is “maximum number of days to clear an invoice payment as agreed between supplier and buyer,” as indicated in FIG. 14. The tertiary factor for the dataset #103 is “Amount Eligible for Cash Discount,” which is “cash discount availed based on the number of days to make a payment,” as indicated in FIG. 14.

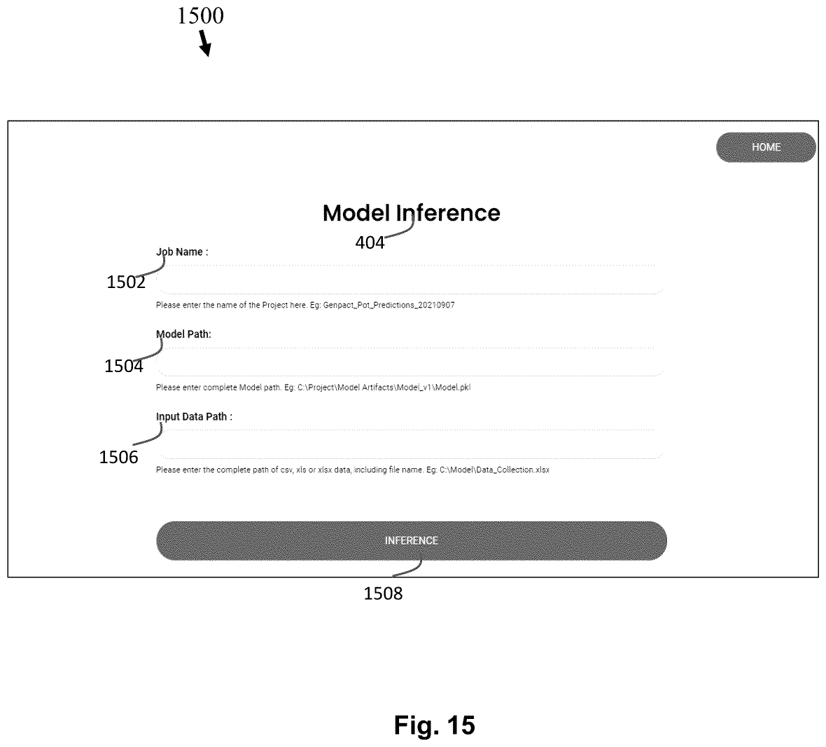

Referring to FIG. 15, a schematic user interface 1500 of a desktop application including the model inference module 404 is shown, according to various embodiments of the present disclosure.

As discussed above in FIG. 4, after the user clicks the model inference module 404, the desktop application of the modelling system enters a user interface 1500, as shown in FIG. 15. The user of the model inference engine in the modelling system needs to provide one or more inputs, which is shown in the user interface 1500.

A first input is a job name 1502. The user of the modelling system may provide any alphanumeric job name. The job name 1502 may be used to create folders in the user's local drive on the user's computer where the desktop application may save logs and model inference reports for the user. The job name 1502 may also be a project name.

A second input is a model data path 1504. The user of the modelling system may provide a file location of the model from the model training earlier in FIG. 6. The path of the model may be a pickle file or anything that is compatible with the modelling system.

A third input is an input data path 1506. The input data path 1506 is a path to the input comma-separated values (CSV) files or Excel files. The desktop application may automatically consider a first column in the dataset as a target variable, and the other variables may be considered as independent variables or features for model inference.

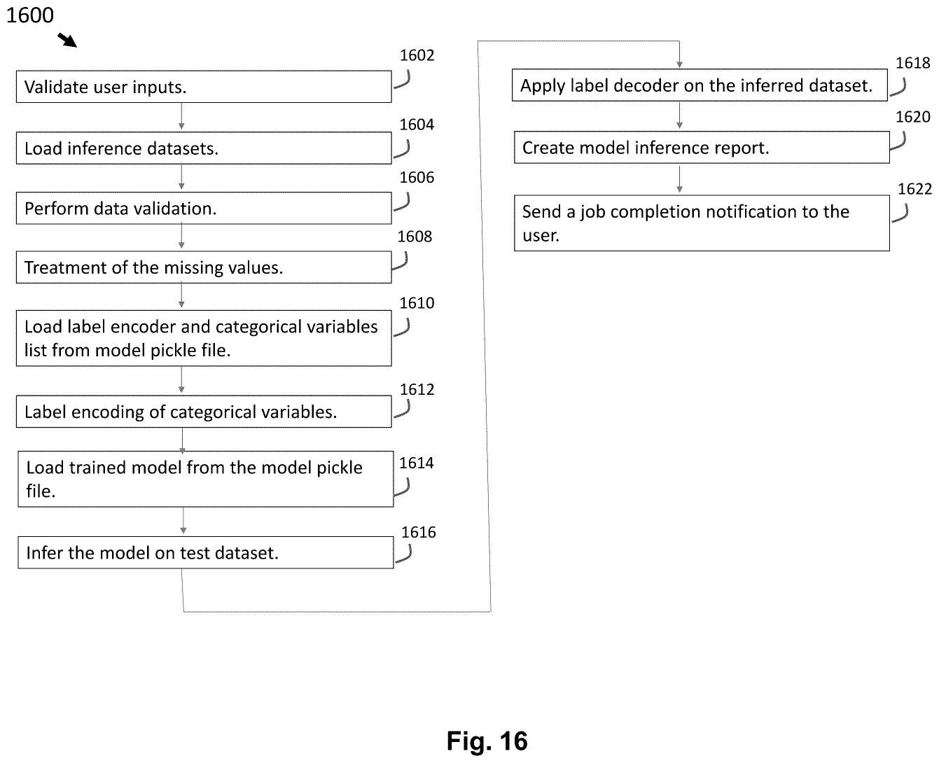

Referring to FIG. 16, a flow diagram 1600 of a model inference process is shown, according to various embodiments of the present disclosure.

At block 1602, user inputs are validated. The validation includes checking if the required fields discussed above in FIG. 15 are provided. The validation also includes validating that the provided format of the inputs is correct. At block 1604, inference dataset is loaded. Input data file formats may be adjudicated. The input data file formats may include csv, xls, or xlsx format. The data is loaded accordingly. At block 1606, data validation is performed. The data validation may include checking all variables provided by the user during the model training may be available in the inference dataset. At block 1608, missing values is treated. For numeric variables, “0” may be used to fill out the missing values by default. For categorical variables, dummy text may be used to fill out the missing values by default.

At block 1610, a label encoder and categorical variables list from model pickle file is loaded. At block 1612, encoding of categorical variables is labelled. At block 1614, trained model from the model pickle file is loaded. At block 1616, the model on test dataset is inferred. At block 1618, a label decoder on the inferred dataset is applied. At block 1620, the model inference report is created. At block 1622, a job completion notification is sent to the user.

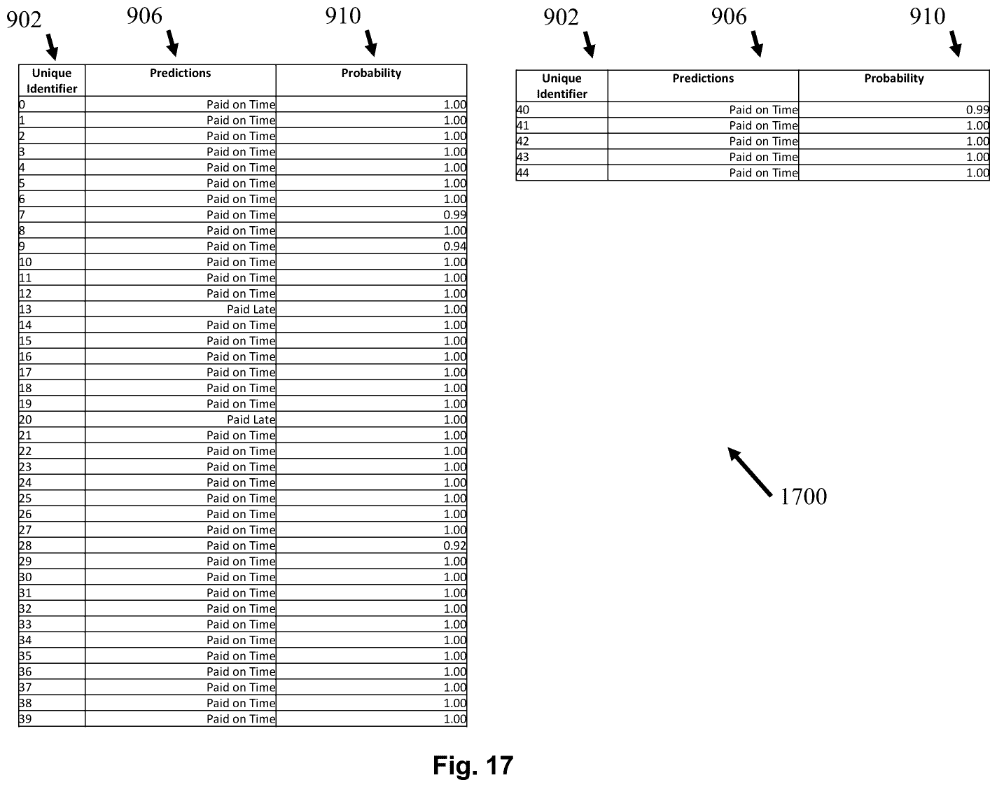

Referring to FIG. 17, an exemplary model prediction report 1700 of a model inference report is shown, according to various embodiments of the present disclosure. It is noted that the model prediction report 1700 is generated once the trained model is inferred on new data for predictions.

In one embodiment, the model prediction report 1700 includes one or more columns, e.g., columns 902, 906, and 1706. For example, the dataset #7 in the model inference report 1700 has a probability 910 of 0.99 or 99% and the prediction 906 for this dataset #7 is paying on time.

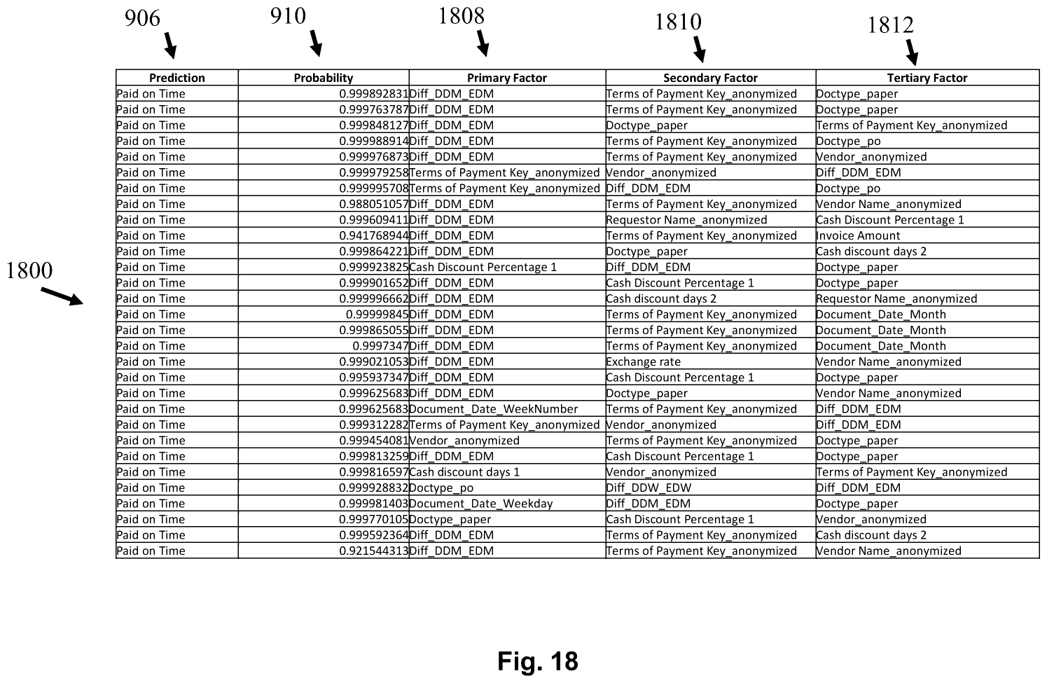

Referring to FIG. 18, an exemplary model explainability report 1800 of the model inference report is shown, according to various embodiments of the present disclosure. It is noted that the model explainability report 1800 is generated once the trained model is inferred on new data for predictions.

The model explainability report 1800 includes one or more columns. The one or more columns include the prediction 906, the probability 910, a primary fator 1808, a secondary factor 1810, and a tertiary factor 1812. The feature in the primary factor 1808 represents a feature with a highest influence for the dataset, therefore, a prediction in the model explainability report 1800 using this feature may be due to value present under this feature in a dataset. In addition, the feature in the secondary factor 1810 represents a feature with a second highest influence for the dataset, and the feature in the tertiary factor 1812 represents a feature with a third highest influence for the dataset. For example, the dataset on the first row in the model explainability report has a prediction score 910 of 0.999892831 and the prediction 906 is that the dataset may pay on time. The primary factor 1808 for the dataset is “Diff_DDM_EDM,” which is a “difference between number of months of the invoice indexing date and invoice date,” as indicated above in FIG. 14. The secondary factor for the dataset is “Terms of Payment Key_anonymized,” which is “maximum number of days to clear an invoice payment as agreed between supplier and buyer,” as indicated above in FIG. 14. The tertiary factor for the dataset is “Doctype_paper,” which is “whether the invoice document is paper or electronic,” as indicated in FIG. 14.

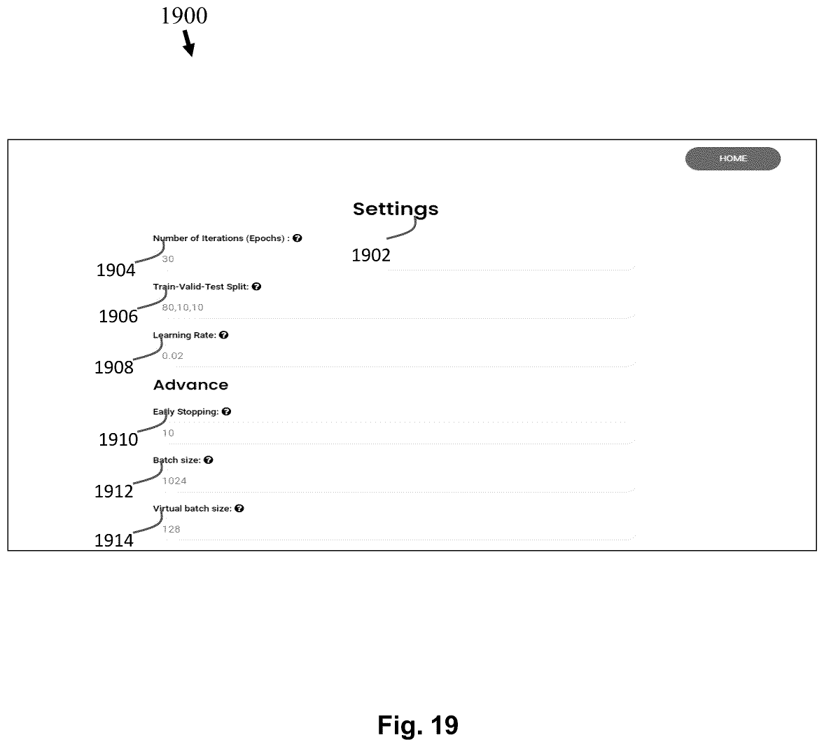

Referring to FIG. 19, a schematic user interface 1900 of model settings is shown, according to various embodiments of the present disclosure.

In one embodiment, the model settings in the user interface 1900 is simple and does not require the users to have knowledge of computer programming and data science. The user interface 1900 only requires one or more user inputs. The one or more user inputs include a number of iterations (e.g., Epochs) 1904, a splitting percentage 1906 of the training data, the validation data, and the testing data and the splitting percentage 1906 may be defined by the user. The one or more user inputs also include a learning rate 1908. The learning rate 1908 may be a tuning parameter in an optimization algorithm that determines the step size at each iteration while moving toward a minimal of a loss function. In some embodiments, the one or more user inputs further include early stopping 1910, a batch size 1912, and a virtual batch size 1914. The early stopping 1910 may be used to avoid overfitting when training the machine learning model with an iterative method. The batch size 1912 may be the number of sample datasets that may pass through to the machine learning model or network at one time. The virtual batch size 1814 may be batch size for ghost batch normalization. In some examples, the ghost batch normalization processes virtual batch size that may be small compared with the regular batch normalization. In an example, the default of the batch size may be 128.

Referring to FIG. 20, a table 2000 of one or more use cases using the application is shown, according to various embodiments of the present disclosure.

The one or more use cases include paid on time optimizer 2020, non-purchase order (PO) general ledger (GL) optimizer 2022, a value added tax (VAT) code predictor 2024, a discount coverage 2026, a pay term-pay run analysis 2028, an outward payment anomaly check 2030.

In one embodiment, an invoice may be mapped to a purchase order (PO) or may be without a purchase order. In the case that the invoice is non-PO type, the finance team uses a general ledger (GL) to track the spending based on a category of the non-PO invoice. For example, the categories may be travel, housekeeping, information technology (IT) equipment, or the like.

In the table 2000, each use case may have a metric impact 2004, vendor experience 2006, efficiency 2008, controllership 2010, profit and loss impact 2012, and working capital impact 2014. For example, the table 2000 may indicate that the paid on time optimizer 2220 may have a positive vendor experience 2006, a higher efficiency 2008, a better controllership 2010, an impact on the profit and loss 2012, and an impact on the working capital 2014.

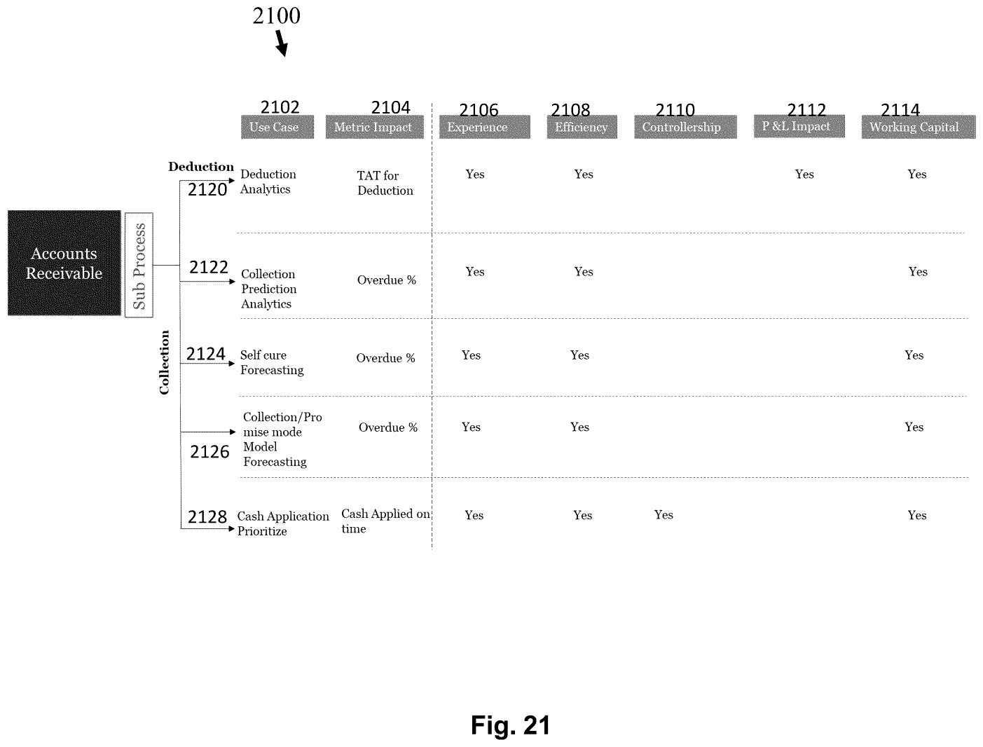

Referring to FIG. 21, a table 2100 of one or more use cases using the application is shown, according to various embodiments of the present disclosure.

The one or more use cases include deduction analytics 2120, collection prediction analytics 2122, self-cure forecasting 2124, collection or promise mode model forecasting 2126, and cash application prioritization 2128.

In the table 2100, each use case may have a metric impact 2104, experience 2106, efficiency 2108, controllership 2110, profit and loss impact 2112, and working capital 2114. For example, the table 2100 may show that the deduction analytics 2120 may have an experience 2106, a higher efficiency 2108, an impact on the profit and loss 2112, and an impact on the working capital 2114 when the application is used on deduction analytics 2120.

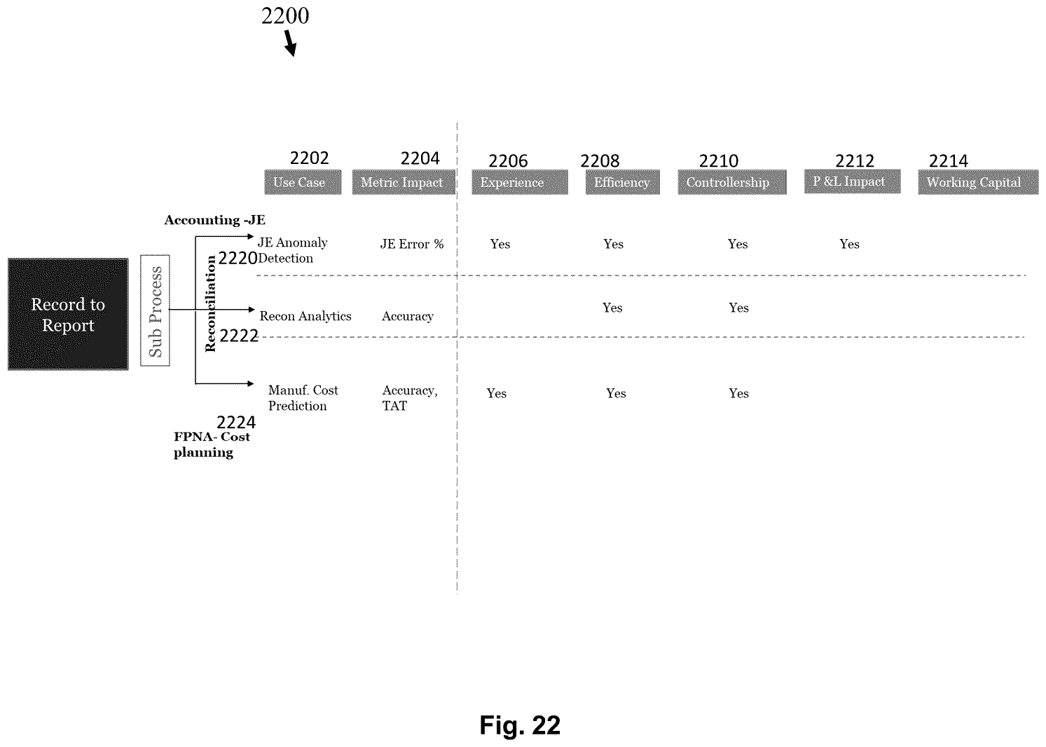

Referring to FIG. 22, a table 2200 of one or more use cases using the application is shown, according to various embodiments of the present disclosure.

The one or more use cases include JE anomaly detection 2220, reconciliation analytics 2222, and manufacture cost prediction 2224.

In the table 2200, each use case may have a metric impact 2204, experience 2206, efficiency 2208, controllership 2210, profit and loss impact 2212, and working capital 2214. For example, the table 2200 may show that the reconciliation analytics 21222 may have a higher efficiency 2208 and a better controllership 2210 when the application is used on the reconciliation analytics 2222.

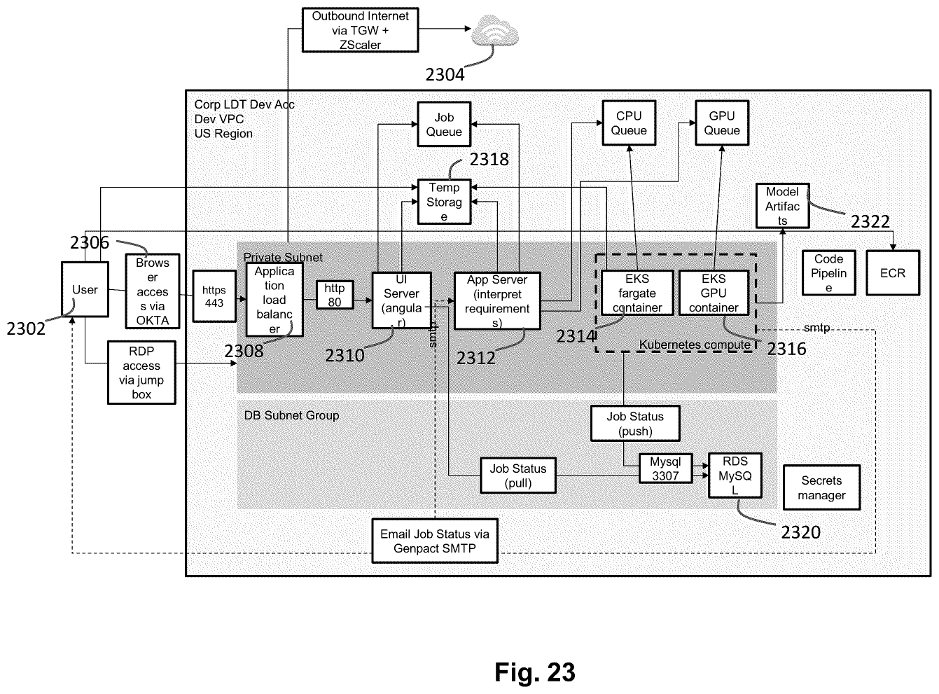

Referring to FIG. 23, a block diagram 2300 of an application based on cloud service is shown, according to various embodiments of the present disclosure.

In the block diagram 2300, a user 2302 may access the application through a browser 2306, and the application may be accessed from a remote cloud server 2304. An application load balancer 2308 may be used between the browser 2306 and a user interface server 2310. The application may have an application server 2312. Both the user interface server 2310 and the application server 2312 connect to a job queue 2318. The block diagram 2300 may also include one or more containers, e.g., container 2314 and container 2316. The containers 2314 and 2316 may store the codes or algorithms, machine learning models, or any files for the machines learning model training.

In one embodiment, the browser 2306 may be used for user authentication. The user interface server 2310 may be a front-end server. The user interface of the user interface server 2310 may be used for following modules user profiling, model training, model inferencing, and job status. The application server 2312 may be used to performs data validations; submit jobs to either central processing unit (CPU) queue or graphics processing unit (GPU) queue based on the resource requirements of the job; send notification to user 2302 on jobs submission status such as success or fail with error log; and update the entry in the structured query language (SQL) database.

In one embodiment, the container 2316 may be docker containers for model training and inferencing. The temporary storage 2318 may be an object storage, which may be used as a transient storage to save the input data and the input data may be deleted automatically as soon as he model training is completed. The RDS MySQL 2320 may be used as a database, which stores user and job level details. The details may include user name, job name, status, accuracy, model path, or the like. The model artifacts may be used to store model artifact files, trained model pickle files, model reports, and model logs.

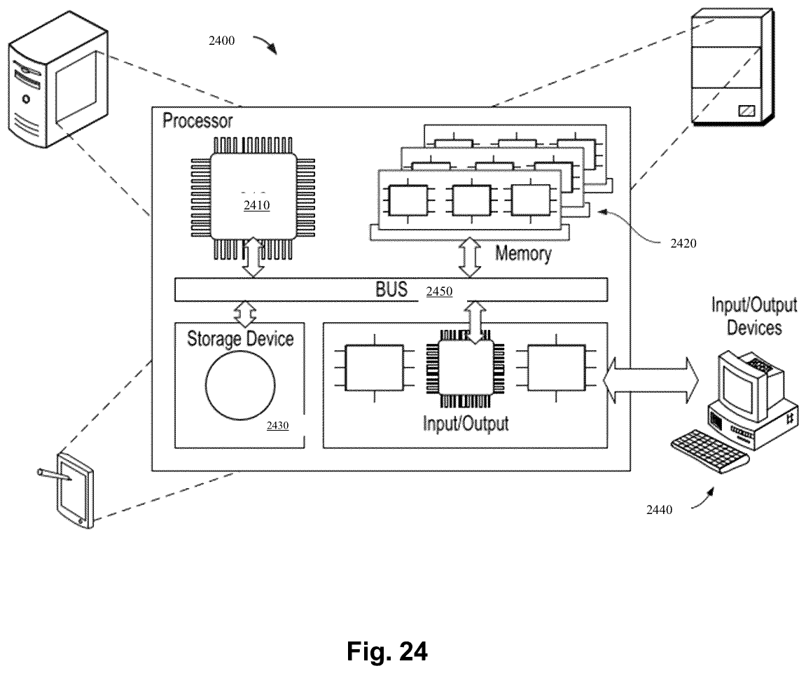

An example of a type of user's computer is shown in FIG. 24, which shows a schematic diagram of a generic computer system 2400. The user interface and machine learning model generation techniques described above may be implemented as a software application and the software application may be used in the user's computer. The user's computer may be a desktop computer or a laptop.

Notably, in some embodiments, the techniques described herein, including machine learning and custom model creation, can be performed on low-end hardware, including virtual machines and Internet of Things (IoT) devices, which may have limited processing and memory resources. The software implementing the described features can make use of third party libraries that accommodate limited resource situations (e.g., the open source machine learning framework, PyTorch). For example, such third party libraries can be configured to use alternative memory resources, such as a hard drive, as working memory when random access memory (RAM) is limited. In another example, such third party libraries can be configured to limit use of processor resources (e.g., if a single core processor is available instead of a multi-core processor, utilization of the single core can be limited so that other functions can continue to be performed using the processor).

The system 2400 may be used for the operations described in association with any of the method, according to one implementation. The functions and the algorithms described above may be performed in the software application in the user's computer. For example, a user of the UI may use the system 2400 to access the user interface. The system 2400 includes a processor 2410, a memory 2420, a storage device 2430, and an input/output device 2440. Each of the components 2410, 2420, 2430, and 2440 is interconnected using a system bus 2450. The processor 2410 is capable of processing instructions for execution within the system 2400. In one implementation, the processor 2410 is a single-threaded processor. In another implementation, the processor 2410 is a multi-threaded processor. The processor 2410 is capable of processing instructions stored in the memory 2420 or on the storage device 2330 to display graphical information, e.g., the user interface on the input/output device 2440.

As discussed earlier, the processor 2410 may be used to calculate the precision rates P1 and P2, and the recall rates R1 and R2. The processor 2410 may be used to create a model, e.g., the predictive machine learning model, as discussed earlier. The processor 2410 may execute the processes, formula, and algorithm in the present disclosure.

The memory 2420 stores information within the system 2400. In one implementation, the memory 220 is a computer-readable medium. In one implementation, the memory 2420 is a volatile memory unit. In another implementation, the memory 2420 is a non-volatile memory unit.

The storage device 2430 is capable of providing mass storage for the system 2400. In one implementation, the storage device 2430 is a computer-readable medium. In various different implementations, the storage device 2430 may be a floppy disk device, a hard disk device, an optical disk device, or a tape device. The storage device 2430 may store data such as input data or training data, as discussed earlier.

The input/output device 2440 provides input/output operations for the system 2400. In one implementation, the input/output device 2440 includes a keyboard and/or pointing device. In another implementation, the input/output device 2440 includes a display unit for displaying graphical user interfaces.

While this specification contains many specific implementation details, these should not be construed as limitations on the scope of what may be claimed, but rather as descriptions of features that may be specific to particular embodiments.

It is to be understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventor did not consider such subject matter to be part of the disclosed inventive subject matter.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

Obviously, numerous modifications and variations are possible in light of the above teachings. It is therefore to be understood that within the scope of the appended claims, embodiments of the present disclosure may be practiced otherwise than as specifically described herein.

1. A method for generating a custom predictive model, the method comprising:
displaying a user interface to a user through a computer application, the user interface having a model training module and a model inference module;
detecting a user interaction with the model training module, wherein in response to the user interaction with the model training module the computer application performs the steps of:
receiving a plurality of datasets;
identifying a plurality of features affecting prediction of a custom predictive model;
determining an importance score for each of the plurality of features;
determining a probability of prediction for each dataset from the plurality of the datasets based on one or more features from the plurality of features for the prediction of each dataset, and respective importance scores for the one or more features;
comparing each probability of prediction of each dataset to a probability threshold;
sending, based on the comparison, datasets of the plurality of datasets to an exception queue;
generating a job at an application server in communication with the computer application based on remaining datasets of the plurality of datasets;
calculating, by the application server, resource requirements of the job;
sending, based on the resource requirements of the job, the job to either a central processing unit queue in communication with a first machine learning model stored in a first virtual container of a container system or a graphics processing unit queue in communication with a second machine learning model stored in a second virtual container of the container system;
training, either the first machine learning model within the first virtual container or the second machine learning model within the second virtual container to produce a custom predictive model, wherein training either the first machine learning model or the second machine learning model includes using the remaining plurality of datasets with the probabilities, the respective features, and the respective importance scores, wherein either the first machine learning model or the second machine learning model is trained for at least an iteration, wherein the training of either the first machine learning model or the second machine learning model includes minimizing a loss function; and
detecting a user interaction with the model inference module, wherein in response to the user interaction with the model inference module the computer application is programmed to perform the step of:
determining a probability of a prediction of a dataset using the trained custom predictive model.

2. The method of claim 1, further comprising displaying a user interface for configuring generation of the custom predictive model, the user interface including:
a first user interface element for selecting a type of the custom predictive model to be generated; and
a second user interface element for identifying one or more categorical variables in one of the datasets.

3. The method of claim 1, further comprising providing an encrypted subscription code to the user interface, wherein the computer application:
decrypts the subscription code using secret-key cryptography-based decryption; and
validates the user has authentication to interact with the computer application based on the decryption.

4. The method of claim 1, wherein the probability of a prediction of a dataset includes a probability of on-time payment of an invoice.

5. The method of claim 1, wherein the custom predictive model provides a ranking of the plurality of features affecting the prediction.

6. The method of claim 1, wherein the custom predictive model provides a comparison of an actual dataset and one or more predictive datasets.

7. The method of claim 6, wherein the custom predictive model provides an accuracy of the prediction based on the comparison.

8. (canceled)

9. The method of claim 1, wherein the custom predictive model provides a data coverage representing a percentage of datasets having a probability greater than a threshold value.

10. A system for generating a customed predictive model, the system comprising:
a memory; and
one or more processors coupled with the memory, wherein the one or more processors, when executed, perform operations comprising:
displaying a user interface to a user through a computer application, the user interface having a model training module and a model inference module;
detecting a user interaction with the model training module, wherein in response to the user interaction of the model training module the computer application performs the steps of:
receiving a plurality of datasets;
identifying a plurality of features affecting prediction of a predictive model;
determining an importance score for each of the plurality of features;
determining a probability of prediction for each dataset from the plurality of the datasets based on one or more features from the plurality of features for the prediction of each dataset, and
respective importance scores for the one or more features;
comparing each probability of prediction of each dataset to a probability threshold;
sending, based on the comparison, datasets of the plurality of datasets to an exception queue;
generating a job at an application server in communication with the computer application based on the remaining datasets of the plurality of datasets;
calculating, by the application server, resource requirements of the job;
sending, based on the resource requirements of the job, the job to either a central processing unit queue in communication with a first machine learning model stored in a first virtual container of a container system or a graphics processing unit queue in communication with a second machine learning model stored in a second virtual container of the container system;
training, either the first machine learning model within the first virtual container or the second machine learning model within the second virtual container to produce a custom predictive model, wherein training either the first machine learning model or the second machine learning model includes using the remaining plurality of datasets with the probabilities, the respective features, and the respective importance scores, wherein either the first machine learning model or the second machine learning model is trained for at least an iteration, wherein the training of either the first machine learning model or the second machine learning model includes minimizing a loss function; and
detecting a user interaction with the model inference module, wherein upon a detection of the user interaction with the model inference module the computer application is programmed to perform the step of:
determining a probability of a prediction of a dataset using the trained custom predictive model.

11. The system of claim 10, further comprising a user interface for configuring generation of the custom predictive model, the user interface including:
a first user interface element for selecting a type of the custom predictive model to be generated; and
a second user interface element for identifying one or more categorical variables in one of the datasets.

12. The system of claim 10, wherein the system has limited resources by at least one of using alternative working memory on the system and restricting processor utilization on the system.

13. The system of claim 10, wherein the plurality of features includes a document type of a dataset in the plurality of datasets and a type of service of datasets in the plurality of datasets.

14. The system of claim 10, wherein the custom predictive model provides a ranking of the plurality of features affecting the prediction.

15. The system of claim 10, wherein the custom predictive model provides a comparison of an actual dataset and one or more predictive datasets.

16. The system of claim 15, wherein the custom predictive model provides an accuracy of the prediction based on the comparison.

17. The system of claim 10, wherein the probability of the prediction indicates a confidence value of the prediction.

18. The system of claim 10, wherein the custom predictive model provides a data coverage representing a percentage of datasets having a probability greater than a threshold value.

19. A non-transitory computer readable medium containing computer-readable instructions stored therein for causing a computer processor to perform operations comprising:
displaying a user interface to a user through a computer application, the user interface having a model training module and a model inference module;
detecting a user interaction with the model training module, wherein in response to the user interaction with the model training module the computer application performs the steps of:
receiving a plurality of datasets;
identifying a plurality of features affecting prediction of a predictive model;
determining an importance score for each of the plurality of features;
determining a probability of prediction for each dataset from the plurality of the datasets based on one or more features from the plurality of features for the prediction of each dataset, and respective importance scores for the one or more features;
comparing each probability of prediction of each dataset to a probability threshold;
sending, based on the comparison, datasets of the plurality of datasets to an exception queue;
generating a job at an application server in communication with the computer application based on the remaining datasets of the plurality of datasets;
calculating, by the application server, resource requirements of the job;
sending, based on the resource requirements of the job, the job to either a central processing unit queue in communication with a first machine learning model stored in a first virtual container of a container system or a graphics processing unit queue in communication with a second machine learning model stored in a second virtual container of the container system;
training, either the first machine learning model within the first virtual container or the second machine learning model within the second virtual container to produce a custom predictive model, wherein training either the first machine learning model or the second machine learning model includes using the remaining plurality of datasets with the probabilities, the respective features, and the respective importance scores, wherein either the first machine learning model or the second machine learning model is trained for at least an iteration, wherein the training of either the first machine learning model or the second machine learning model includes minimizing a loss function; and
detecting a user interaction with the model inference module, wherein upon a detection of the user interaction with the model inference module the computer application is programmed to perform the step of:
determining a probability of a prediction of a dataset using the trained custom predictive model.
